(19) United States
(12) Patent Application Publication
(10) Pub. No.: US 2009/0178050 A1
(43) Pub. Date: Jul. 9, 2009

(54) Control of Access to Services and/or Resources of a Data Processing System

(75) Inventors: Martin Bichler, Garching (DE); Thomas Setzer, München (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/991,824

(22) PCT Filed: Sep. 12, 2006
(86) PCT No.: PCT/EP2006/008878

§ 371 Date: Jan. 16, 2009

(30) Foreign Application Priority Data
Sep. 12, 2005 (EP) 05019817.5

(51) Int. Cl. G06F 9/46

(52) U.S. Cl. 718/104

(57) ABSTRACT

In order to control access to resources of a data processing system, a priority code is determined for an access request to at least one resource. A comparison code for granting access to the at least one requested resource is determined concerning an alternative use of the resource. For a totality of resource requests to the data processing system, an extreme value for a sum is determined via products of a corresponding priority code and of a number of resource accesses which can be granted in each case, taking into account a maximum capability of a requested resource. For a resource request, it is checked whether the priority code and the comparison code show a predetermined mutual relation. Access is granted depending on the extreme value determined and on the result of the check.

### CROSS REFERENCE TO RELATED APPLICATIONS

This application is the US National Stage of International Application No. PCT/EP2006/008878, filed Sep. 12, 2006 and claims the benefit thereof. The International Application claims the benefits of European Patent Office application No. 05019817.5 EP filed Sep. 12, 2005, both of the applications are incorporated by reference herein in their entirety.

### FIELD OF INVENTION

The present invention relates to a method for controlling access to services of a data processing system having at least one resource, to a method for controlling access to resources of a data processing system, and to a control program.

### BACKGROUND OF INVENTION

Virtualization concepts are based on the separation of logical and physical resources and thereby result in more efficient use of data processing systems and IT infrastructure. Resources additionally required in the short term are allocated dynamically from resource pools when needed. Resources can be considered to be all factors which are essential for providing an electronic service, for example CPU cycles, main memory, I/O, network bandwidth, licenses or power. Equally, the joint use of hardware by various applications on a server or the division of resources for multilayer web applications can also be termed a form of virtualization.

However, the use of virtualization techniques requires concepts for resource allocation and the management of service agreements (service level management—SLM) by IT service providers. With a high workload, shortages may arise in resource pools even in virtualized infrastructures, which means that it is no longer possible to respond to all service requests. Particularly in the case of a severely fluctuating workload or as a result of the loss of resources, the load appearing can exceed the capacities provided. In such phases of overload, services need to be authorized or rejected on the basis of their priorities, which means that the total damage or the costs of temporary undercapacity are minimized. In this context, the priority of a service is dependent upon what relevance its implementation has on the basis of service agreements (service level agreements—SLA). In contrast to the case of dedicated allocation of resources to particular services, heterogeneous services compete with different priorities and resource requests for scarce resources. Even with incomplete resource utilization, the available remaining capacity for a jointly used resource falls whenever a request is served for the period of service provision, which is accompanied by rising opportunity costs. Opportunity costs are a comparison variable for missed profit, yield or benefit from the best of the unselected alternatives for using goods.

A few previously known approaches for controlling access to resources in a data processing system have concerned themselves with access control for web servers. X. Chen, P. Mohapatra and H. Chen, “An Admission Control Scheme for Predictable Server Response Time for Web Accesses”, World Wide Web Conference, 2001 and M. Rumsewicz, M. Castro and M. Tai Le, “Eddie Admission Control Scheme: Algorithm Description, Prototype Design Details and Capacity Benchmarking”, Sourceforge 1999, propose how, in the event of an overload, the requests from individual users can be authorized or rejected (session-based admission control), and not individual HTTP requests from all the users. This means that the service can be maintained for already accepted users even when there is an overload.

Eggert and J. Heidemann, “Application-Level differentiated service from an internet server”, World Wide Web Journal, vol. 3, pp. 133-142, 1999, discloses an access control method for web servers with two different user classes. In this case, a distinction is drawn between HTTP requests which are sent by the user and those which the proxy server initiates (proxy prefetching), only simple web servers with static contents being considered.

A. Verma and S. Ghosal, “On Admission Control for Profit Maximization of Networked Service Providers”, World Wide Web Conference, Budapest, Hungary, 2003 describes a general access control method for IT service providers with a scarce resource which considers the forecast period of a service request, the yield when a defined response time is observed and contractual penalties when it is not observed.

S. Elnikety, E. Nahum, J. Tracey and W. Zwaenepoel, “A Method for Transparent Admission Control and Request Scheduling in E-Commerce Web Sites”, World Wide Web Conference, New York, N.Y., USA, 2004, discloses a simple access control method for multilayer web applications in which the number of access operations is limited in order to keep the response time within certain limits. The approach is based on estimating the required period for a service request and measuring the system capacity.

Optimizing access guidelines to web applications with different response time guarantees which are installed on a set of web servers is described in Z. Liu, M. S. Squillante and J. L. Wolf, “On Maximizing Service-Level-Agreement Profits”, 3rd ACM Conference on Electronic Commerce, Orlando, Fla., USA, 2001. Use is made of a queue network for modeling the system architecture and of optimization models with simultaneous consideration of contractual penalties when the response time is not observed. In this context, it is assumed that the average resource requirement for all the applications is lower than the available resources.

### SUMMARY OF INVENTION

The present invention is based on the object of specifying methods for efficient control of the access to services or resources of a data processing system and suitable implementations of the methods.

The invention achieves this object by means of a method and a control program having the features specified in the independent claims. Advantageous refinements of the present invention are specified in the dependent claims.

In line with the invention, for controlling access to services of a data processing system having at least one resource, a linear optimization model is used to ascertain, for a collectivity of service requests to the data processing system within a stipulated planning period, an extreme value from a number of respectively grantable service access operations and from a priority coefficient for the respective service taking account of resources available in the planning period and of resource requests forecast for the planning period as a result of expected service requests. Opportunity costs for resources of the data processing system are ascertained from accounting prices in the linear optimization model. A comparison coefficient is ascertained for the grant of the access to a service which requires units of one or more resources over one or more units of time. The comparison coefficient is ascertained from a sum relating to products of resource units used by a service, from a forecast period of resource use and from opportunity costs ascertained at a request time per resource unit and time unit.

A check is performed for a service request to determine whether the priority coefficient associated with a service exceeds the comparison coefficient. The access is granted on the basis of the ascertained extreme value and the result of the check.

Accounting prices describe an effect which provision of an additional resource unit for a unit of time has on the extreme value of the optimization model when there is a binding secondary condition. The comparison coefficient therefore quantifies all of the opportunity costs which accompany the granting of particular access to a service.

In line with the invention, for controlling access to resources of a data processing system, a priority coefficient for a request for access to at least one resource is ascertained. In addition, a comparison coefficient for grant of the access to the at least one requested resource is ascertained for alternative use of the resource. An extreme value for a sum relating to products is ascertained, for a collectivity of resource requests to the data processing system, from a respective priority coefficient and from a number of respectively grantable resource access operations taking account of a maximum capability of a requested resource. A check is performed for a resource request to determine whether the priority coefficient and the comparison coefficient have a prescribed ratio to one another. The access is granted on the basis of the ascertained extreme value and the result of the check.

The present invention is based on yield management approaches which reserve capacities for high-priority service users and allocate the remaining capacity for other customer segments. In this case, differentiation can take place on the basis of qualitative features of the service.

Virtualized IT infrastructures provide a series of heterogeneous resources. Virtualized resources can be used to satisfy demand in a wide variety of segments or service classes. Constraints in IT resource networks lead to assumptions which call for new approaches to modeling in comparison with yield management approaches for airlines, where demand for resources is usually continuous. In IT resource networks, the reservation and actual consumption of a service normally take place simultaneously or in real time and not at different times, as is the case in the hotel sector or with airlines. In addition to the described area of use for the present invention for IT service providers with a virtualized infrastructure, the inventive method can be transferred to areas in which heterogeneous services access jointly used resources stochastically. Examples of this are call centers, power supply or media rental, particularly video libraries.

In line with one development of the present invention, resources are requested by services and/or applications. Furthermore, the comparison coefficient can show opportunity costs for use of a resource. Preferably, the priority coefficient increases as the priority of a resource request increases, which means that the extreme value is a maximum.

In line with one preferred refinement of the present invention, the priority coefficient is a monetary variable for rating a relevance and/or a value of a resource request, and a check is performed to determine whether the priority coefficient is greater than the comparison coefficient. Furthermore, expenses in connection with rejection of a resource request can be additionally incorporated into the ascertainment of the extreme value. The extreme value is advantageously ascertained by a deterministic linear program.

Preferably, the maximum capability of a requested resource is ascertained taking account of a forecast demand for the requested resource within a prescribable period and a resource utilization level at a prescribable time. A correction value can also be calculated for the maximum capability of a requested resource on the basis of forecast remaining periods of resource requests requesting access to the resource, and this correction value can be incorporated into the ascertainment of the extreme value. Correction values indicating relevant components of a period of use of a requested resource as a result of a resource request within a prescribable period can be calculated for the resource requests too and can be incorporated into the ascertainment of the extreme value. In addition, the comparison coefficient can be ascertained in real time for each instant of a resource request.

In addition, all of the resources of the data processing system may have a degree of heterogeneity, and arbitrary resource types may be taken into account for the access control. Preferably, the access control involves optimization over a plurality of services in a service portfolio, a plurality of heterogeneous resources being able to be used simultaneously by a service.

The inventive method for controlling access to resources of a data processing system can be implemented using a control program which can be loaded into a main memory in a data processing installation and has at least one code section whose execution prompts a priority coefficient for a request for access to at least one resource to be ascertained. In addition, it prompts a comparison coefficient for grant of the access to the at least one requested resource to be ascertained for alternative use of the resource. It prompts an extreme value for a sum relating to products to be ascertained, for a collectivity of resource requests to the data processing system, from a respective priority coefficient and from a number of respectively grantable resource access operations taking account of a maximum capability of a requested resource. Furthermore, it prompts a check to be performed for a resource request to determine whether the priority coefficient and the comparison coefficient have a prescribed ratio to one another. The maximum capability of a requested resource is ascertained taking account of a forecast demand for the requested resource within a prescribable period and of a resource utilization level at a prescribable time. The access is granted on the basis of the ascertained extreme value and the result of the check, when the control program is executed in the data processing installation.

It is accordingly possible to implement the inventive method for controlling access to services of a data processing system having at least one resource.

### BRIEF DESCRIPTION OF THE DRAWINGS

The present invention is explained in more detail below using an exemplary embodiment with reference to the drawing, in which

FIG. 1 shows a schematic illustration of a resource matrix,

FIG. 2 shows a schematic illustration of a resource matrix taking account of different resource use periods,

FIG. 3 shows a schematic illustration of an approximation of available resource capacity,

FIG. 4 shows a schematic illustration of an approximation of future resource use,

FIG. 5 shows a schematic illustration of forecast service requests,

FIG. 6 shows a schematic illustration of evenly distributed demand times,

FIG. 7 shows a schematic illustration of calculation of a first correction factor,

FIG. 8 shows a schematic illustration of calculation of a second correction factor,

FIG. 9 shows a flow diagram for a simulation implementation, and

FIG. 10 shows a graph containing simulation results.

### DETAILED DESCRIPTION OF INVENTION

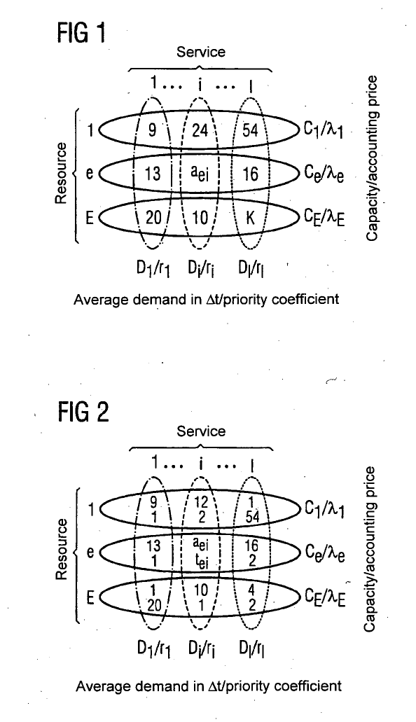

The present example assumes that resources of an IT service provider of I different services i (i=1, . . . , I) are accessed, the access operations taking place at discrete times tₖ (k=0, . . . , ∞) on average Dᵢ times. Dᵢ is assumed to be constant and independent of past service demand times and quantities. The period of use for the resources used in the course of providing a service and that for actually providing the service are assumed to be of constant length Δt (Δt=tₖ₊₁−tₖ) and hence concluded at the next possible respective demand time tₖ₊₁. Resource use coefficients aₑᵢ indicate the requirements or use quantity for units of the resource e (e=1, . . . , E) for the period Δt. A resource e has a limited capacity Cₑ. Resource use coefficients aₑᵢ for individual services, such as CPU cycles, main memory in bytes or I/O in blocks, can be ascertained by means of measurements in an isolated test environment, such as are used for load tests and software acceptance, with a sufficiently high level of accuracy. A basic model is first of all parameterized deterministically using the average of the resource requirements. FIG. 1 illustrates the stated correlations.

The available resources will now be used in optimum fashion for responding to service requests taking into account service priorities. Under the stated assumptions, the problem can be formulated by an integer linear program (integer program—IP).

$$max {\sum }_{i \leq I} {r}_{i} \cdot {x}_{i}$$

$$s . t . {\sum }_{i \leq I} {a}_{ei} {x}_{i} \leq {C}_{e} ∀ e \leq E$$

$$\begin{matrix}{x}_{i} \leq {D}_{i} & ∀ i \leq I \\ {x}_{i} ∈ {Z}_{+} & ∀ i \leq I\end{matrix}$$

The integer variable xᵢ describes the number of service requests to be accepted for a time period Δt. The coefficient rᵢ quantifies the priority of a service and assumes values from the range of positive real numbers, where rᵢ rises with increasing priority. In this context, the priority coefficient rᵢ can be interpreted equivalently to a monetary variable which represents the relevance or the value within the context of avoiding damage or cost by providing a service.

The random variable Dᵢ is treated as a deterministic variable in this formulation. If all the restrictions for the decision variables and the right-hand side of the equation system are integer in a linear program (LP), which is the case in our situation, the equation system's solutions are integer and the IP can be resolved by LP relaxation, a deterministic linear program (DLP). Details in this regard can be found in E. L. Williamson, “Airline Network Seat Control”, Cambridge, Mass., USA: MIT, 1992.

The dual variables λₑ for the capacity restrictions of the LP relaxation can be interpreted economically as accounting prices or opportunity costs for the use of a resource unit. Opportunity costs of a request for service i can be calculated by adding the products of the resource use coefficient and opportunity costs per resource unit (Σₑ aₑᵢ λₑ). In line with the present example, exclusively service requests are accepted whose priority coefficient exceeds the value of the opportunity costs which service acceptance would cause.

Automatic measurement and monitoring of IT services are becoming an ever greater reality today as a result of IT service management tools. This includes detecting infringements of SLAs directly and including them in contractual penalties. Under these assumptions, any rejection of a service request could also have associated explicit costs or contractual penalties which are taken into account in the decision model. Appropriate contractual penalties can be taken into account in the above basic model by means of target programming, for example.

$$max {\sum }_{i \leq I} ( {r}_{i} \cdot {x}_{i} - {p}_{i} {d}_{i -} )$$

$$\begin{matrix}s . t . {\sum }_{i \leq I} {a}_{ei} {x}_{i} \leq {C}_{e} & ∀ e \leq E\end{matrix}$$

$$\begin{matrix}{x}_{i} + {d}_{i -} = {D}_{i} & ∀ i \leq I \\ {x}_{i} , {d}_{i -} \geq 0 & ∀ i \leq I\end{matrix}$$

In this formulation, pᵢ represents the contractual penalty for rejecting a request for a particular service. The slack variable dᵢ quantifies the negative discrepancies from the currently forecast demand Dᵢ, which arise as a result of resources being too scarce.

### Model with Continuous Service Demand

The basic model variant described above assumes service requests at discrete times whose handling is concluded at the next discrete demand time. IT service providers are often confronted by continuous service demand, and different services have different handling times. Services thus use resources not only in particular quantities, but rather also for particular periods. The resource use matrix needs to be expanded by a time dimension tᵢ which indicates for how many units of time a service i uses aₑᵢ units of a resource e (see FIG. 2).

This dispenses with prescribed, discrete planning intervals. Resources may be almost fully utilized one moment and available again almost to maximum capacity in the next moment, following the end of active service requests. The aim of the access control model is to deny requests for low-priority services in anticipation on the basis of available resource quantities in order to reserve resources for requests for higher-priority services. First, the resource units available in the planning interval can therefore be determined, and secondly, it is possible to stipulate planning intervals which are as short as possible. The requirement for short planning intervals and hence the most exact determination possible of current resource utilization levels can be taken into account by virtue of the accounting prices being recalculated at every service demand time and planning horizons respectively being placed onto the forecast end times for resource use by the requested services. In the case of severe fluctuations in demand, this realtime calculation of the opportunity costs for every service request in Monte Carlo simulations would give better results than the calculation at firmly prescribed times. In scenarios with 100 service types and 10 jointly used resources, the periods for calculating the opportunity costs of a service request are usually significantly below 10 ms on a Pentium III 2 GHz processor and therefore do not need to be considered in most real world scenarios.

In the case of sequential instead of parallel resource access, for example in the case of a typical 3-layer web application architecture comprising web, application and database servers, it is additionally possible to specify the order in which the resources are used.

To parameterize the decision model for the recalculation of the opportunity costs, it is necessary to determine the present utilization level for the resources used by the service and for service requests still expected in the planning interval. In line with the basic model variant, the capacity restrictions taken are all the resource capacities Cₑ if no services are active at the discrete calculation times for the next planning interval and hence all capacities are available. In the case of continuous service demand, however, resources may be partially in use by active services at the moment of accounting price calculation and are not available again for services requested in the planning interval until the active services release them again. The optimization program is parameterized with capacity restrictions which are too generous, which means that excessively low opportunity costs are calculated and hence not enough capacity is reserved. Ascertainment of the resource utilization levels at the service request time, for example using system monitoring tools, provides the currently available capacities. However, parameterizing the optimization program with these capacity restrictions provides excessively high accounting prices, since this assumes that the currently used resources remain in use for the entire planning period. If service requests are terminated during the planning interval, however, the resource units which are then free again are available for services requested after this time.

### Inclusion of Active Services in the Planning Interval

On the basis of results from Monte Carlo simulations, the linear program operates very restrictively in respect of resource requests, particularly in the case of very heterogeneous services. The following heuristic improves the method's results. The heuristic comprises calculation steps for approximating the capacities which are actually available in the planning interval and the resource requirement in the planning interval and leads to an improvement in the results in the simulations described in more detail later.

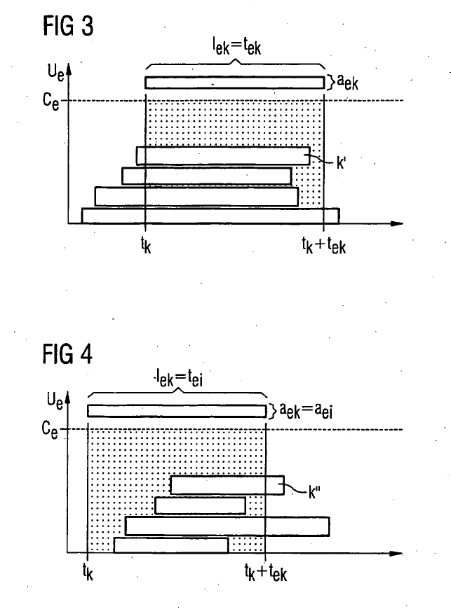

Throughout the analyzed period, that is to say the sequence of all the planning intervals considered, a total of K service requests arrive, each individual service request k, where k=1, . . . , K, being associated with a particular service or a service class i. At the time tₖ of an arriving request k for service i, the planning periods for all the resources e required by service i are set to the probable period of resource use by request k with service class i (tₑₖ=tₑᵢ). Resource planning horizons are therefore respectively lₑₖ=tₖ+tₑₖ (see FIG. 3). The steps below are then performed for all the resources e where aₑₖ=aₑᵢ>0.

The forecast remaining running times l_{ek′} for the uses of e from tₖ by currently active service requests k′ are determined. The resource use periods for active services are thus shortened by the time component ahead of tₖ which has already been completed and is therefore not relevant for a decision.

For all k′ whose forecast termination times for the use of the resource e are after the time tₖ+tₑₖ (exceed lₑₖ), their remaining running time l_{ek′} going into the model is limited to the interval lₑₖ which is relevant for a decision.

The total Σ_{k′} a_{ek′} l_{ek′} for all the active services k′ corresponds to the capacity units of e which are no longer available for the current service request and new service requests in the period under consideration lₑₖ. Subtracting this value from the theoretically maximum capacity lₑₖ Cₑ (Cₑ corresponds to the capacity of e per unit of time) in lₑₖ gives the capacity units Cₑₖ which are still available throughout the interval. This value can now be used as an approximation of the capacity which is available in the planning period.

The previously calculated Cₑₖ indicate the available capacity units in the resource planning intervals lₑₖ, these being able to differ for different resources e. It is necessary to determine the requests xᵢ to be accepted on the basis of the expected demand for services, which is proportional to the length of the planning interval. If the planning interval chosen is the longest interval max(lₑₖ), the capacities Cₑₖ available for the shorter intervals need to be projected for the interval max(lₑₖ).

$${\tilde{C}}_{ek} = \frac{max ( {l}_{ek} )}{{l}_{ek}} {C}_{ek}$$

### Planning-Irrelevant Time Components for Future Service Requests

In similar fashion to the described limitation of t_{ek′}, it is also not necessary to take account of the full length of the requirements of the service requests k″ which are still to be expected in the interval lₑₖ, but rather they can be limited to the end of the planning period tₖ+tₑₖ (see FIG. 4), since resource uses after this time are no longer directly relevant to the acceptance/rejection decision for the request k.

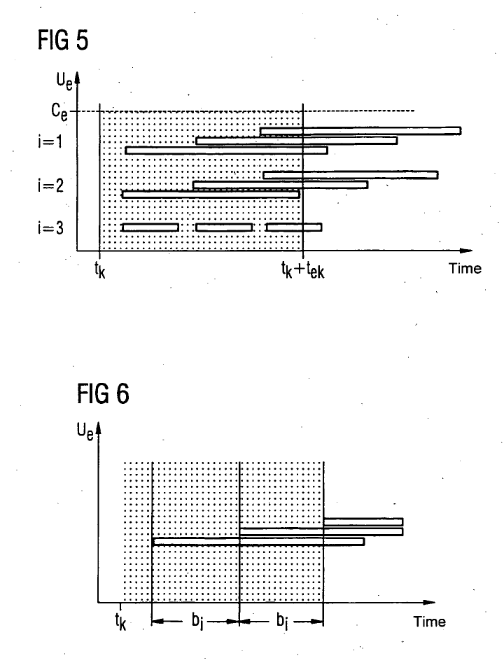

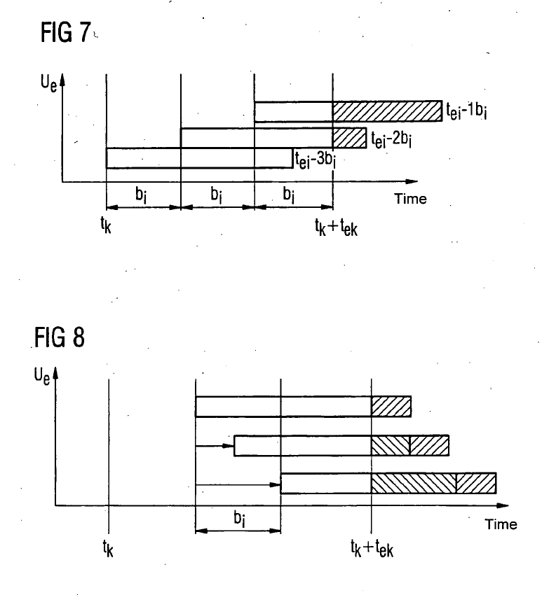

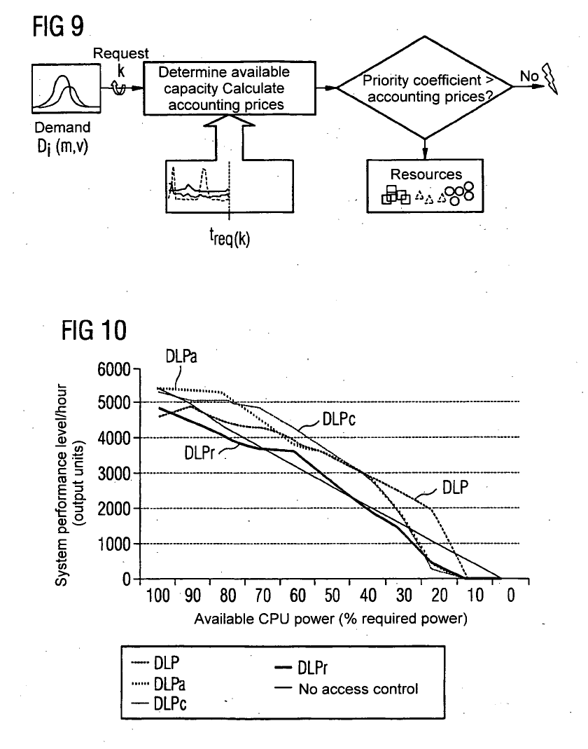

It is therefore necessary to stipulate correction factors qₑᵢ for all the services, said correction factors indicating the relevant components of the periods of use of a resource e by a service in the planning interval. If a plurality of requests for a service i are expected in an interval, it is assumed that the service requests are evenly distributed over the interval. FIG. 5 shows different services i for a forecast demand of 3 service requests in the planning interval.

Whereas, in the case of service 1, all three expected service requests have a time component for use of the resource which is outside the planning period, services 2 and 3 are each expected to have uses of resources by service requests which are fully inside the planning interval, that is to say including those which are partially outside. As can be seen in FIG. 5, the correction factors for the three services are different. If it is assumed that the times at which a service i is demanded are evenly distributed over a planning interval, the correction factors qₑᵢ can be calculated using the heuristic described below, and hence the periods of use by future service requests which are relevant to the planning can be approximated.

If lₑₖ denotes the planning period for a resource e and Dᵢ denotes the expected level of demand for service i per unit of time, the average period between adjacent requests for a service i in lₑₖ (see also FIG. 6) is found to be:

$${b}_{i} = \frac{{l}_{ek}}{{D}_{i}}$$

To deal with the stochastic nature of demand, it is assumed that demand times may be distributed arbitrarily in bᵢ. If the resource use period tₑᵢ exceeds the ascertained value bᵢ then the component tᵢ−bᵢ of the last request is outside the planning interval, regardless of the exact demand time in bᵢ.

$${\sum }_{j = 0 , … , {D}_{i - 1}} max ( 0 , {t}_{ei} - ( j + 1 ) \cdot {b}_{i} )$$

On the basis of the assumption of random arrival of a request during an interval bᵢ, it is additionally necessary to ascertain the resultant components which are to be corrected on average. Possible request times for the expected service request within an interval bᵢ are shown in FIG. 8. The diagonally striped component of tₑᵢ shows, as already described, the component which is always outside the planning interval. The lengthwise striped component shows the component which can assume values between 0 and bᵢ, depending on the exact request time. Assuming that the probability of arrival of the third service request is evenly distributed, this component corresponds on average to 0.5bᵢ.

In this case too, this component is reduced on average by a respective demand interval length bᵢ for the preceding service requests. The component of the resource use periods for requests for a service type i in the planning interval lₑₖ which is outside the planning interval therefore needs to be extended by the following total:

$${\sum }_{j = 0 , … , {D}_{i - 1}} min ( \frac{{b}_{i}}{2} , \frac{{t}_{ei} - j \cdot {b}_{i}}{2} )$$

The total found for the resource uses by a service i which are not relevant to the planning is:

$${Ext}_{ei} = {\sum }_{j = 0 , … , {D}_{i - 1}} \{ \begin{matrix}max ( 0 , {t}_{ei} - ( j + 1 ) \cdot {a}_{ei} ) + 0 , when \frac{{t}_{ei} - j \cdot {a}_{ei}}{{b}_{i}} <= 0 \\ max ( 0. {t}_{ei} - ( j + 1 ) \cdot {a}_{ei} ) + \frac{{t}_{ei} - j \cdot a}{{b}_{i}} \cdot \\ min ( \frac{{a}_{ei}}{2} , \frac{{t}_{ei} - j \cdot {a}_{ei}}{2} ) , when 0 < \frac{{t}_{ei} - j \cdot {a}_{ei}}{{b}_{i}} < 1 \\ max ( 0 , {t}_{ei} - ( j + 1 ) \cdot {a}_{ei} ) + min ( \frac{{b}_{i}}{2} , \frac{{t}_{ei} - j \cdot {a}_{ei}}{2} ) , \\ when \frac{{t}_{ei} - j \cdot {a}_{ei}}{{a}_{ei}} >= 1\end{matrix}$$

This results in the correction factor

$${q}_{ei} = \frac{{Ext}_{ei}}{{D}_{i} \cdot {t}_{ei}} .$$

The continuous, deterministic program can therefore be used as a decision model for every new service request and takes account both of the heuristic for determining available capacities and of the heuristic for determining the actual resource requirements in the planning interval.

$$max {\sum }_{i \leq I} {r}_{i} \cdot {x}_{i}$$

$$s . t . {\sum }_{i \leq 1} {a}_{ei} {q}_{ei} {t}_{ei} {x}_{i} \leq \frac{max ( {l}_{ek} )}{{l}_{ek}} {C}_{ek} ∀ e \leq E$$

$$\begin{matrix}{x}_{i} \leq max ( {l}_{ek} ) {D}_{i} & ∀ i \leq I \\ {x}_{i} ∈ {Z}_{+} & ∀ i \leq I\end{matrix}$$

The continuous, deterministic program and related heuristics represent a model abstraction of really occurring phenomena in IT systems. The continuous, deterministic program considers resource use coefficients both for period and for quantity per unit of time as deterministic, static variables. Laboratory-conducted measurements of resource requirements (CPU time, main memory use and I/O) from web applications indicate a low level of variance, even in the case of severe alterations in the workload. In reality, resource requirements are stochastic in terms of quantity and period, for example the duration of a database query as the size of the database increases or the requests are parameterized differently. In addition, it is assumed that free resource units can be used arbitrarily within the planning period. However, the experiments described below show that the model assumptions were sufficiently accurate to bring about improvements in comparison with simple access control methods.

### Simulation Design and Results

The models described above calculate opportunity costs for services and are used within the context of access control and load balancing methods. To arrive at statements about the efficiency of the models, the formulations are evaluated in Monte Carlo simulations. The efficiency criterion is the total of assumed service requests multiplied by corresponding priority coefficients for the services for various capacities and different volatility of demand in a period. This total is subsequently referred to as system performance level. For this, service requests for service portfolios compiled heterogeneously in respect of priorities and resource requirements are generated in line with stochastic demand distributions. At the beginning of each planning interval, the resource capacities available during the interval are ascertained and these are used to calculate the accounting prices per resource unit and time unit. If the total of the accounting prices for all the resources Σₑ aₑₖ tₑₖ tₑᵢ used by a request k for service i exceeds the priority coefficient for the service, or if sufficient resources are no longer available for providing the service, a service request is denied. Otherwise, a service is performed. FIG. 10 shows the further simulation in schematic form.

The text below describes a scenario which simulates a standard IBM xSeries application server on which, besides others, five different service classes i=1, . . . 5 are formed and provided. The service classes differ in terms of their priority (their value) while having identical functionality, service agreements and resource use coefficients. The services are accessed with a normal distribution with expected values Dᵢ and standard deviations Sᵢ=0.25 Dᵢ per second. According to S. Elnikety, J. Tracey, E. Nahum and W. Zwaenepoel, “A Method for Transparent Admission Control and Request Scheduling in E-Commerce Web Sites”, Management Science, vol. XX, 2003, the variances in the resource uses on an application server in phases of incomplete utilization of the server are small. Full utilization levels for a server, and thus a significant reduction in the execution times even for already active services, are largely avoided by means of the access control methods described. rᵢ denotes the priority coefficient for a service i. The services jointly access the resources CPU and RAM of the server and the I/O for the memory network. The simulation parameters are shown in a table below.

| | | rᵢ | | RAM | CPU | I/O |
|---|---|---|---|---|---|---|
| i | id | (output units) | Dᵢ/min | (MByte) | (cycles) | (MByte |
| 1 | S12 | 0.011 | 10 | 24 | 62 | 6.5 |
| 2 | S123 | 0.08 | 10 | 24 | 62 | 6.5 |
| 3 | P2 | 0.015 | 10 | 24 | 62 | 6.5 |
| 4 | S2 | 0.02 | 10 | 24 | 62 | 6.5 |
| 5 | S23 | 0.025 | 10 | 24 | 62 | 6.5 |

The capacities or the maximum outputs of the resources under consideration are

CPU: 3.2 GHz, Intel Xeon processor,

RAM: 4 gigabytes, DDR II SDRAM,

I/O: 1 gigabit/s, Gigabit Ethernet.

Resource use coefficients for the services describe the number of CPU cycles required for service execution within one second (CPU), the amount of main memory used during service execution in megabytes (RAM), the volume of data to be transmitted from the memory network to the server during execution of a service (I/O).

In the cited scenario, the purpose of better analysis of the simulation results is served by choosing the resource dimensions to be such that bottlenecks occur exclusively for the resource CPU, since the capacities of the resources RAM and I/O have large dimensions in comparison with the load which is to be expected. The execution of the operating system, the monitoring of the resource utilization levels etc. account for 0.1 GHz of CPU power, so that 3.1 GHz of CPU power is available for the services. Starting with an available CPU power of 3.1 GHz, the quantity of CPU cycles available per second is decremented progressively in 0.062 GHz steps per simulation round. This is done by performing additional services every second which use exactly this quantity of CPU cycles. A simulation round comprises 10 respective simulations with identical available CPU power, and these are used to form average values. The system performance level under access control is respectively compared with that without access control. Services are denied only if they cannot be provided within one second after the request time on account of the CPU's utilization level being too high.

For all the models evaluated, the optimization problem is formulated as a deterministic, linear program. Planning interval periods for which optimization is performed and on the basis of which the accounting prices of the resources are each recalculated are 10 seconds. The continuous, deterministic program (DLPc) performs re-optimization for every request and sets the planning period to one second, since on the basis of service agreements it is possible to provide services within one second after request. This is approximated in the model by means of parameterization of the decision model with a resource use of 1 GHz for one second. The basic model variant (DLP) always parameterizes the model with the complete 3.1 GHz as a capacity restriction, whereas the variant DLPr derives free capacity from an average CPU utilization level for the second before the recalculation of the accounting prices. The variants DLPa and DLPc incorporate the resources which become free again in the planning interval into the optimization at the same time. Similarly, in the case of variants DLPa and DLPc, the resource use periods for services expected in the planning interval are limited to the planning interval end times. FIG. 11 shows the results of the simulation.

The simulation results show that as the load on jointly used resources increases (in the present case as a result of the progressive reduction in the available CPU cycles), the advantages as a result of use of the access control methods become greater at first, as expected, but decline as the resources become increasingly scarce, and even become negative when resource quantities are very low.

The reason for the increasing advantages as a result of the use of the access control method is that as the scarcity of resources increases it becomes increasingly important to take account of the priority of services and hence to allocate resources efficiently. If the number of CPU cycles available for the five service types falls by 30% for an hour, for example as a result of increased demand for other services which are likewise executed on the application server, then the system performance level is likewise reduced by on average 30% from 5436 output units to 3751 output units. The use of the access control methods can in this case significantly increase the system performance level. By way of example, use of the method based on the variant DLPc allows a system performance level of 4869 output units instead of 3751 output units to be achieved, which corresponds to an increase of 1118 output units or 30% per hour for a total of 3000 requests to the five services per minute.

The decrease in the efficiency at low capacities is a typical characteristic which can also be observed in yield management methods for airlines (see M. Lewis, H. Ayhan, and R. Foley, “Bias optimal admission control policies for a multi-class non-stationary queuing system”, Journal of Applied Probability, vol. 39, pp. 20-37, 2002). Accounting prices are set too conservatively, that is to say too high. If, by way of example, a premium service P expects two requests in a planning interval but a standard service S expects ten requests then, with a capacity of ten units and resource use coefficients of one in each case, all ten requests for S would be blocked in order to guarantee that the two premium services are accepted, even if the priority coefficient for P is just slightly above that for S. This problem can be alleviated by artificially differentiating between identical services, for example using minimal variations in the priority coefficients.

In that scenario, the more exact methods of variants DLPc and DLPa are superior to the more static methods of variants DLP and DLPr for capacities above 40%, but not below this capacity limit. The variant DLP parameterizes using all the capacities, that is to say normally expects more capacity than is actually available in the planning period. The lack of optimization clarity as a result of excessive accounting prices and overly generous capacity restrictions therefore compensate for one another in part, which results in a high efficiency for the variant DLP in comparison with the other methods.

The method described here differs in many respects from conventional access control methods. The developed method performs anticipatory optimization and considers a plurality of services in a service portfolio which can each use a plurality of heterogeneous resources, and not just one scarce resource, simultaneously. The resultant combinatorics require new modeling approaches. Although flow coordination methods optimize the allocation of a plurality of resources by a plurality of services by including priorities and service agreements, these methods can be used exclusively for asynchronous services in which the time of performance is of no importance to the service demander. In addition, no response times are modeled in the method described here, as is usually the case in queue networks.

1.-17. (canceled)

18. A method for controlling access to services of a data processing system having at least one resource, comprising
ascertaining, via a linear optimization, for a collectivity of service requests to the data processing system within a stipulated planning period, an extreme value from a number of respectively grantable service access operations and from a priority coefficient for the respective service taking account of resources available in the planning period and of resource requests forecast for the planning period as a result of expected service requests;
ascertaining opportunity costs for resources of the data processing system from accounting prices in the linear optimization model;
ascertaining a comparison coefficient for the grant of the access to a service which requires at least one unit of at least one resource over at least one unit of time;
ascertaining a comparison coefficient from a sum relating to products of resource units used by a service, from a forecast period of resource use and from opportunity costs ascertained at a request time per resource unit and time unit;
checking for a service request to determine whether the priority coefficient associated with a service exceeds the comparison coefficient; and
granting the access basis on the ascertained extreme value and the result of the check.

19. The method as claimed in claim 18, wherein an estimate of available capacities is made on the basis of physical capacities of individual resources and taking account of services already provided in the data processing system and of future service requests expected in the planning period.

20. The method as claimed in claim 18, wherein correction values are ascertained for the service requests for services already provided in the data processing system and for resource requests for expected future service requests, said correction values indicating components of a period of use of a resource requested by a service which are relevant to the planning period, and being incorporated into the ascertainment of the extreme value.

21. A method for controlling access to resources of a data processing system, comprising:
ascertaining a priority coefficient for a request for access to at least one resource;
ascertaining a comparison coefficient for grant of the access to the at least one requested resource for alternative use of the resource;
ascertaining an extreme value for a sum relating to products, for a collectivity of resource requests to the data processing system, from a respective priority coefficient and from a number of respectively grantable resource access operations taking account of a maximum capability of a requested resource;
checking for a resource request to determine whether the priority coefficient and the comparison coefficient have a prescribed ratio to one another;
granting the access on the basis of the ascertained extreme value and the result of the check; and
ascertaining the maximum capability of a requested resource taking account of a forecast demand for the requested resource within a prescribed period and of a resource utilization level at a prescribable time.

22. The method as claimed in claim 21, wherein resources are requested by services and/or applications, a priority coefficient is associated with a service or an application, and the extreme value for a sum relating to products is ascertained from a respective priority coefficient and from a number of respectively grantable service or application access operations.

23. The method as claimed in claim 21, wherein the comparison coefficient is opportunity costs for use of a resource.

24. The method as claimed in claim 21, wherein the priority coefficient increases as the priority of a resource request increases, and the extreme value is a maximum.

25. The method as claimed in claim 21, wherein the priority coefficient is a monetary variable for rating a relevance and/or a value of a resource request, and a check is performed to determine whether the priority coefficient is greater than the comparison coefficient.

26. The method as claimed in claim 21, wherein expenses in connection with rejection of a resource request are additionally incorporated into the ascertainment of the extreme value.

27. The method as claimed in claim 21, wherein the extreme value is ascertained by a deterministic linear program.

28. The method as claimed in claim 21, wherein a correction value is calculated for the maximum capability of a requested resource on the basis of forecast remaining periods of resource requests requesting access to the resource, and this correction value is incorporated into the ascertainment of the extreme value.

29. The method as claimed in claim 21, wherein correction values indicating relevant components of a period of use of a requested resource as a result of a resource request within a prescribable period are calculated for the resource requests and are incorporated into the ascertainment of the extreme value.

30. The method as claimed in claim 21, wherein the comparison coefficient is ascertained in real time for each instant of a resource request.

31. The method as claimed in claim 21, wherein all of the resources of the data processing system have a degree of heterogeneity, and arbitrary resource types are taken into account for the access control.

32. The method as claimed in claim 21, wherein the access control involves optimization over a plurality of services in a service portfolio, a plurality of heterogeneous resources being able to be used simultaneously by a service.

33. A control program for granting access to services of a data processing system having at least one resource, which program can be loaded into a main memory in a data processing installation and has at least one code section whose execution, comprising:
a linear optimization model to be used to ascertain, for a collectivity of service requests to the data processing system within a stipulated planning period, an extreme value from a number of respectively grantable service access operations and from a priority coefficient for the respective service taking account of resources available in the planning period and of resource requests forecast for the planning period as a result of expected services requests;
opportunity costs for resources of the data process system to be ascertained from accounting prices in the linear optimization model:
a comparison coefficient to be ascertained for the grant of the access to a service which requires at least one unit of at least one resource over at least one unit of time:
the comparison coefficient to be ascertained from a sum relating to products of resource units used by a service;
from a forecast period of resource use and from opportunity costs ascertained at a request time per resource unit and time unit;
a check to be performed for a service request to determine whether the priority coefficient associated with a service exceeds the comparison coefficient; and
the access to be granted on the basis of the ascertained extreme value and the result of the check,
when the control program is executed in the data processing installation.

34. A control program for granting access to resources of a data processing system, which program can be loaded into a main memory in a data processing installation and has at least one code section whose execution, comprising:
a priority coefficient for a request for access to at least one resource to be ascertained;
a comparison coefficient for grant of the access to the at least one requested resource to be ascertained for alternative use of the resource;
an extreme value for a sum relating to products to be ascertained, for a collectivity of resource requests to the data processing system, from a respective priority coefficient and from a number of respectively grantable resource access operations taking account of a maximum capability of a requested resource;
a check to be performed for a resource request to determine whether the priority coefficient and the comparison coefficient have a prescribed ratio to one another,
the access to be granted on the basis of the ascertained extreme value and the result of the check;
the maximum capability of a requested resource to be ascertained taking account of a forecast; and
demand for the requested resource within a prescribed period and of a resource utilization level at a prescribable time,
when the control program is executed in the data processing installation.
